(19) United States
(12) Patent Application Publication
(10) Pub. No.: US 2009/0262535 A1
(43) Pub. Date: Oct. 22, 2009

(54) Wall Lamp

(76) Inventor: Michel Maillet-Jegou, Saint-Sebastien Sur Loire (FR)

Correspondence Address: YOUNG & THOMPSON, 209 Madison Street, Suite 500, ALEXANDRIA, VA, 22314, US

(21) Appl. No.: 12/285,518

(22) Filed: Oct. 7, 2008

(30) Foreign Application Priority Data
Apr. 22, 2008 (FR) 08.02240

(51) Int. Cl. F21V 33/00; F21S 13/02

(52) U.S. Cl. 362/253; 362/432

(57) ABSTRACT

The wall lamp according to the invention includes: a support structure obtained by cutting/folding a metallic plate and includes a planar body, the two facing ends of which are extended by at least one folded integral flap, an intermediate flap extending from the planar body, folded at right angle relative to the latter, which intermediate flap includes a circular or arc-shaped border, a socket of the type having an externally threaded cylindrical body, provided with a rest flange and a screw tightening ring, which socket is mounted on the intermediate flap by sandwiching of the border thereof between the rest flange and the tightening ring, and a screen consisting of an added-on plate made of a flexible bendable material, held on the support structure, after bending, by cooperation of the two end borders thereof with the folded flaps of the support structure.

The present invention relates to wall lamp structures for space lighting and/or for insect trapping.

There exist many wall lamp types or models adapted for lighting rooms or premises, or else for trapping insects, in particular in association with a glue-coated plate.

However, present wall lamps have complex structures or need implementation of complex means, which made them rather costly.

The present invention aims to propose a novel wall lamp structure, the constituent parts as well as the assembly and implementation of which are very simple.

So, the wall lamp according to the invention comprises a support structure for a socket receiving an electric bulb, provided with a power supply cable, and for a screen adapted to partially mask said bulb so as to obtain an indirect lighting; and this wall lamp is characterized in that
said support structure is obtained by cutting/folding a metallic plate and comprises a planar body, two facing ends of which are extended by at least one folded integral flap, which folded flaps extend on a same side of said planar body; further, an intermediate flap extends from the planar body, between said folded flaps and on the same side of the latter, taken from the surface of said planar body and folded at right angle relative to the latter, which intermediate flap comprises a circular or arc-shaped border;
the electric socket is of the type having an externally threaded cylindrical body, provided with a rest flange and a screw tightening ring; this socket is mounted on the intermediate flap of the support structure by sandwiching of the circular or arc-shaped border thereof between said rest flange and said tightening ring;
the screen consists of an added-on plate made of a flexible bendable material, having two parallel end borders; this plate/screen is held on the support structure, after bending, by cooperation of the two end borders thereof with said folded flaps of the support structure, shaped to that purpose or provided with suitable means.

According to a possible embodiment, the two ends of the support structure comprise an edge defined by said folded flap(s), and one at least of said edges has the function to rigidly restrain one of the end borders of the plate/screen.
In this framework, the support structure can comprise a tab, partially cut from the surface thereof and connected by a folding line which extends over the rigid-restraining edge of the end border of the plate/screen, said tab being folded toward the associated end flap, so as to clamp and hold said end border of the plate/screen.

According to an embodiment variant, at least one of the end flaps of the support structure comprises two parallel through-groves for the rigid restraining of one of the end borders of the plate/screen.

According to a preferred embodiment, the two ends of the support structure consist of two successive flaps, folded around parallel folding lines, the first one, called “inner flap”, being extended by the second one, called “end flap”.

Preferably, the two ends of the support structure provided with folded flaps are superimposed, one corresponding to the upper end and the other to the lower end.
In this framework, the flap(s) of the lower end of the support structure comprise(s) a through-groove for the power supply cable of the bulb supporting socket to pass-trough and to be locked.

According to a particularly interesting embodiment:
the two ends of the support structure consist of two successive flaps folded around parallel folding lines;
these two ends of the support structure, provided with couples of folded flaps are superimposed, one corresponding to the upper end and the other to the lower end;
the two parallel facing edges which connect the couples of upper and lower folded flaps are separated by a distance d, which is greater than the distance separating the two end borders of the plate/screen, when the latter is not bent, each of said end borders being, after the bending of said plate/screen, rigidly restrained in the opposite edge that connects the couples of lower and upper flaps.

Still preferably, the intermediate flap of the support structure comprises a generally semi-circular-shaped end border, adapted for the fixation to the bulb supporting socket.

According to the particular embodiment, the “back” face of the plate/screen, directed toward the electric bulb and support structure side, is coated with a sticky matter of the glue-type, so as to obtain an insect-trap wall lamp.

The invention will be further illustrated, without being in any way limited, by the following description of a particular embodiment, given only by way of example and shown in the attached drawings, in which:

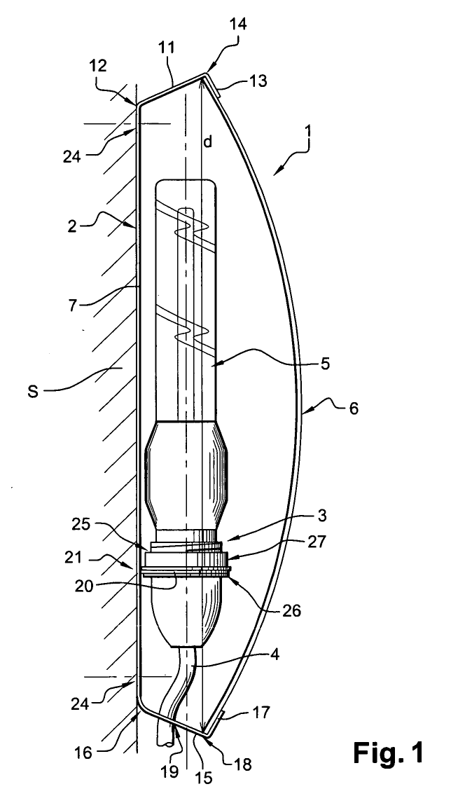

FIG. 1 is a side view of a wall lamp according to the invention;

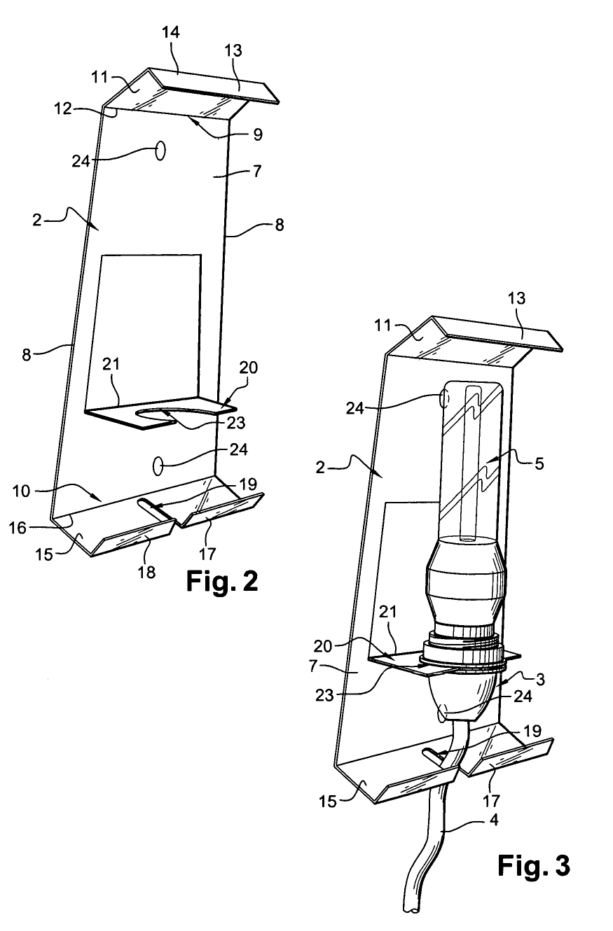

FIG. 2 shows in a perspective view the support structure of the wall lamp illustrated in FIG. 1;

FIG. 3 shows the support structure of FIG. 2 equipped with the associated socket and electric bulb;

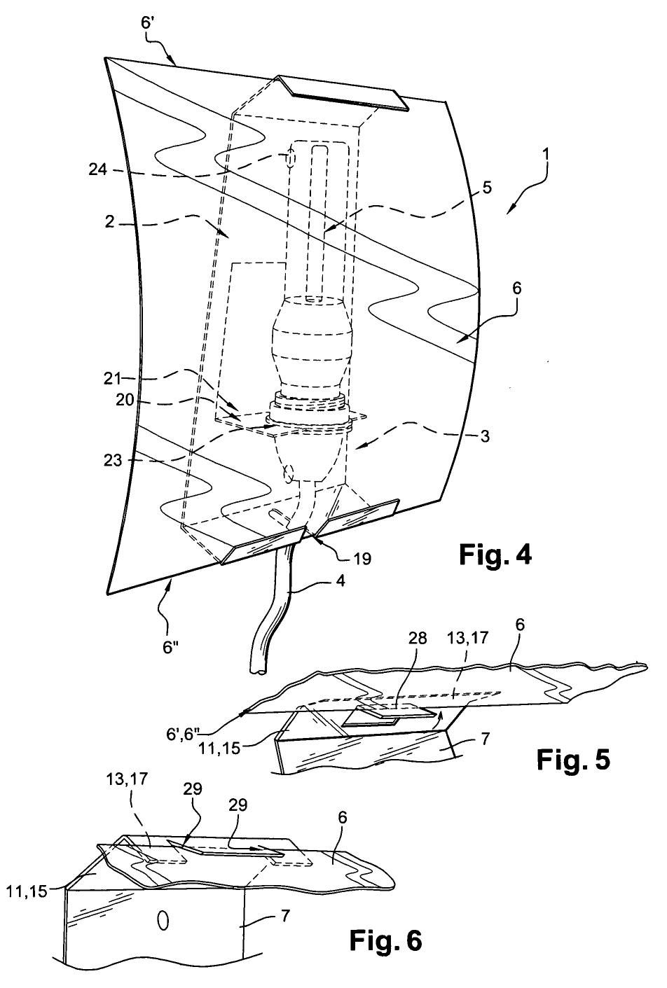

FIG. 4 is a perspective view of the wall lamp illustrated in FIG. 1, after mounting of the plate/screen on the unit illustrated in FIG. 2;

FIG. 5 is a partial view that shows a possible complementary means for holding one of the ends of the plate/screen on the support structure;

FIG. 6 illustrates an embodiment variant of the means for holding the plate/screen on the support structure.

The wall lamp 1 shown in FIGS. 1 to 4 comprises—a support structure 2,—a socket 3 with a supply cable 4, provided with an electric bulb 5, and—a front screen 6 adapted to partially mask the electric bulb 5 so as to obtain an indirect lighting.

The support structure 2 is formed by cutting and folding a small-thickness metallic plate (e.g. in galvanized steel of 1 mm thick), having a rectangular general shape.

This support structure 2 comprises a rectangular planar body 7 delimited by two side borders 8, an upper border 9 and a lower border 10.

The upper border 9 is extended by two folded integral flaps, an “inner” one 11, connected to the planar body 7 by the folding line 12, and an end one 13, connected to said inner flap 11 by the folding line 14. The two folding lines 12 and 14 are parallel to each other. The dihedron defined by the planar body 7 and the inner flap 11 forms an angle of about 100 to 130°, and the dihedron defined by the inner flap 11 and the end flap 13 forms an angle of about 80° to 100°.

The lower border 10 is extended by two folded flaps, an “inner” one 15 (connected to the planar body 7 by the folding line 16) and the other an “end” one 17 (connected to the inner flap 15 by the folding line 18).
The two folding lines 16 and 18 are parallel to each other and parallel to the aforementioned folding lines 12 and 14 of the upper end of the structure. The folding angles of the lower flaps 15 and 17 are identical or similar to those of the upper flaps 11 and 13. Thus, the dihedron defined by the planar body 7 and the inner flap 15 forms an angle of about 100 to 130°, whereas the dihedron defined by the two flaps 15 and 17 forms an angle of about 80 to 100°.

In FIGS. 2 to 4, it can be noticed that the two lower flaps 15 and 17 comprise a median through-groove 19.

On the other hand, an intermediate flap 20 is cut from the planar body 7 and connected to the latter by a folding line 21.
This flap 20 is folded at right angle relative to the planar body 7 (around the folding line 21) so as to extend on the same side of this planar body 7 as the couples of end flaps 11-13 and 15-17.
The folding line 21 is parallel to the folding lines 12, 14, 16 and 18 of the upper and lower flaps 11, 13, 15 and 17.

In FIGS. 2 to 4, it can still be noticed that the end border 23 of the intermediate flap 20, opposite to the folding line 21, has a semi-circular shape.

The planar body 7 of the support structure 2 further comprises two openings 24 for the fixation thereof to any support S, e.g. a vertical wall (FIG. 1).

In the normal position, fixed to the receiving wall S thereof, the planar body 7 extends in a vertical plane, the intermediate flap 20 extends in a horizontal plane, and the folding lines 12, 14, 16 and 18 extend horizontally.
The couples of folded flaps 11-13 and 15-17 are superimposed, located on a same vertical axis.

The horizontal flap 20 forms the support member for the electric socket 3. This socket 3 is of the type having a threaded cylindrical body 25 provided with an inner cylindrical shoulder 26 and a tightening ring 27 that screws onto said threaded body 25. The positioning of the socket 3 is made through sandwiching the end border 23 of the flap 20 between the lower cylindrical shoulder 26 and the tightening ring 27. The axis of the cylindrical socket 3 extends parallel to the plane of the planar body 7. To obtain a correct locking, the semi-circular border 23 of the flap 20 has a diameter identical to that of the socket cylindrical body 25.

This fastening method for the bulb socket 3 is particularly simple and fast to implement.

The socket 3 is advantageously of the E27 or E14 type, adapted to receive an electrical bulb 5 to be screwed onto, the cap of which has a diameter of 27 mm or of 14 mm respectively. Any type of bulb 5 can be used: conventional light, ultraviolet, black light..

Under the body 25 of the socket 3, the supply cable 4 extends vertically downward and passes through the groove 19 arranged in the two lower flaps 15 and 17; this groove 19 is advantageously sized, in the width direction, so as to slightly squeeze the cable 4 to hold it in position.

The screen 6 is formed by means of an added-on plate made of a flexible bendable material, e.g. cardboard or plastic material, having here a rectangular general shape.

This plate 6 is manually bent from top to bottom, and the two upper 6′ and lower 6″ borders thereof, parallel to each other, are inserted or rigidly restrained in the edges corresponding to the two parallel folding lines 14 and 18, between the two upper flaps 11, 13 and the two lower flaps 15, 17 of the support structure 2. To this end, the distance d which separates the two facing rigid-restraining edges 14 and 18, is smaller than the distance between the two borders 6′ and 6″ of the plate/screen 6 when the latter is not bent.

The plate/screen 6 is kept inside corresponding dihedrons 11-13 and 15-17 thanks to the elasticity of the material, because of the applied bending.
The angle between the two couples of flaps 11-13 and 15-17, and the direction of said flaps, are adapted for the correct holding of the plate 6.

Notches can be provided in the median part of the upper 6′ and lower 6″ borders of the plate/screen 6, the width of which is slightly greater than the width of the flaps 11, 13, 15, 17, to ensure the bending and the side holding of said plate/screen 6 on the support structure 2.

The plate 6 is thus positioned on the other side of the support structure 2 relative to the electric socket 3 and the associated bulb 5; and then it serves as a partial screen in front of the bulb 5, to produce an indirect lighting wall lamp.

It is well understood that this plate/screen 6 has a particularly simple structure and is very easy to mount and to remove/reposition. This plate/screen 6 is preferably fully opaque; the visible (front) face thereof can comprise an ornament or an advertising message or the like; it can also be solid coloured, e.g. white, silver or gold.

In a particular embodiment, the non-visible (or bulb-side, back) face of this plate/screen 6 can be coated with a sticky matter, e.g. glue, so as to form an insect trap lamp. This sticky matter can be applied by any suitable means on the back of the support plate 6, e.g. by sticking of a glue-coated woven fabric.

The plate/screen 6 can have any general shape, as long as the upper 6′ and lower 6″ border parts thereof cooperating with the support structure 2 are adapted for providing a correct holding.

As illustrated in FIG. 5, in an embodiment variant, a tab 28 is cut from the inner flap 11 and/or 15 of the support structure 2, and hinged around the folding line 14/18, to enable clamping of the corresponding border of the plate/screen 6.
This tap 28 forms a complementary means for holding the plate/ screen 6. Preferably, it is only provided at the upper extension of the planar body 7 (i.e. the couple of folded flaps 11-13), but it can also be arranged at the lower extension, on either side of the groove 19.

Another means to hold the plate/screen 6 on the support structure 2 consists, as illustrated in FIG. 6, in arranging two parallel grooves 29 in either or both end flaps 13, 17. These two parallel grooves 29 enable the borders 6′ and/or 6″ of the plate/screen 6 to be rigidly restrained, which ensure that the plate/screen 6 is correctly maintained in position.

In a simplified embodiment variant, the planar body of the support structure can be extended, at the two facing ends thereof, by a single flap positioned according to an adapted angle to ensure the correct holding of the plate/screen, either by rigidly restraining the borders thereof in the edges defined by the folding line between said planar body and said associated end flap, or by rigidly restraining the borders thereof in two parallel grooves arranged in said end flaps (similar to the grooves 29 in FIG. 6).

Generally, it will be noted that any combination of the above described plate/screen fastening methods can be contemplate, at the upper and lower ends of the wall lamp support structure.

In an embodiment variant, the support structure can be arranged so as to cooperate with an added-on base enabling the wall lamp to be laid on a horizontal support.

The invention provides a wall lamp having a support structure and a plate/screen that are very easy to make, and using widely-marketed socket and bulb. This wall lamp, which is also very easy to assemble, has an original appearance, decorated at will with ornaments applied on the plate/screen back.

1. A wall lamp comprising a support structure (2) for a socket (3) receiving an electric bulb (5), provided with a power supply cable (4), and for a screen (6) adapted to partially mask said bulb (5) so as to obtain an indirect lighting, characterized in that said support structure (2) is obtained by cutting/folding a metallic plate and comprises a planar body (7), two facing ends (9, 10) of which are extended by at least one folded integral flap (11, 13; 15, 17), which folded flaps (11, 13; 15, 17) extend on a same side of said planar body (7), an intermediate flap (20) extending from said planar body (7), between said folded flaps (11, 13; 15, 17) and on the same side of the latter, taken from the surface of said planar body (7) and folded at right angle relative to the latter, which intermediate flap (20) comprises a circular or arc-shaped border (23), and in that it comprises a socket (3) of the type having an externally threaded cylindrical body (25), provided with a rest flange (26) and a screw tightening ring (27), which socket (3) is mounted on said intermediate flap (20) of said support structure (2) by sandwiching of the circular or arc-shaped border (23) thereof between said rest flange (26) and said tightening ring (27), and in that it comprises a screen (6) consisting of an added-on plate made of a flexible bendable material, having two parallel end borders (6′, 6″), said plate/screen (6) being held on said support structure (2), after bending, by cooperation of the two end borders (6′, 6″) thereof with said folded flaps (11, 13; 15, 17) of said support structure (2), shaped to that purpose or provided with suitable means.

2. The wall lamp according to claim 1, characterized in that the two ends of the support structure (2) comprise an edge (14, 18) defined by said folded flap(s) (11-13; 15-17), one at least of said edges (14, 18) having the function to rigidly restrain one of the end borders (6′, 6″) of said plate/screen (6).

3. The wall lamp according to claim 2, characterized in that the support structure (2) comprises a tab (28), partially cut from the surface thereof and connected by a folding line which extends over the rigid-restraining edge (14, 18) of the end border (6′, 6″) of the plate/screen (6), which tab (28) is folded toward the associated end flap (13, 17), so as to clamp and hold said end border (6′, 6″) of the plate/screen (6).

4. The wall lamp according to claim 1, characterized in that at least one of the end flaps (13, 17) of the support structure (2) comprises two parallel through-groves (29) for the rigid-restraining of one of the end borders (6′, 6″) of the plate/screen (6).

5. The wall lamp according to claim 1, characterized in that the two ends of the support structure (2) consist of two successive flaps (11, 13; 15, 17), folded around parallel folding lines (12, 14; 16, 18), the first one (11, 15), called “inner” flap (11 and 15), being extended by the second one (13, 17), called “end” flap.

6. The wall lamp according to claim 5, characterized in that the two ends of the support structure (2) provided with folded flaps (11-13; 15-17) are superimposed, one corresponding to the upper end and the other to the lower end.

7. The wall lamp according to claim 6, characterized in that the flap(s) (15, 17) of the lower end of the support structure (2) comprise(s) a through-groove (19) for the power supply cable (4) of the bulb supporting socket (3) to pass-trough and to be locked.

8. The wall lamp according to claims 5 claim 6, in combination, the two parallel facing edges (14, 18) which connect the couples of upper and lower folded flaps (11, 13; 15, 17) are separated by a distance d, which is greater than the distance separating the two end borders (6′) and (6″) of the plate/screen (6), when the latter is not bent, the upper border (6′) of the plate-screen (6) being rigidly restrained in the edge (14) defined by the two folded flaps (11 and 13), and the lower border (6″) thereof being rigidly restrained in the edge defined by the two lower folded flaps (15 and 17).

9. The wall lamp according to claim 1, characterized in that the intermediate flap (20) of the support structure (2) comprises a generally semi-circular-shaped end border (23).

10. The wall lamp according to claim 1, characterized in that it comprises a plate/screen (6), the “back” face of which, directed toward the electric bulb (5) and support structure (2) side, is coated with a sticky matter of the glue-type, so as to obtain an insect trap lamp.

11. The wall lamp according to claim 1, characterized in that the two ends of the support structure (2) provided with folded flaps (11-13; 15-17) are superimposed, one corresponding to the upper end and the other to the lower end.

12. The wall lamp according to claim 11, characterized in that the flap(s) (15, 17) of the lower end of the support structure (2) comprise(s) a through-groove (19) for the power supply cable (4) of the bulb supporting socket (3) to pass-trough and to be locked.

13. The wall lamp according to claim 2, characterized in that at least one of the end flaps (13, 17) of the support structure (2) comprises two parallel through-groves (29) for the rigid-restraining of one of the end borders (6′, 6″) of the plate/screen (6).

14. The wall lamp according to claim 2, characterized in that the two ends of the support structure (2) consist of two successive flaps (11, 13; 15, 17), folded around parallel folding lines (12, 14; 16, 18), the first one (11, 15), called “inner” flap (11 and 15), being extended by the second one (13, 17), called “end” flap.

15. The wall lamp according to claim 2, characterized in that the two ends of the support structure (2) provided with folded flaps (11-13; 15-17) are superimposed, one corresponding to the upper end and the other to the lower end.

16. The wall lamp according to claim 2, characterized in that the intermediate flap (20) of the support structure (2) comprises a generally semi-circular-shaped end border (23).

17. The wall lamp according to claim 2, characterized in that it comprises a plate/screen (6), the “back” face of which, directed toward the electric bulb (5) and support structure (2) side, is coated with a sticky matter of the glue-type, so as to obtain an insect trap lamp.
